(19) United States
(12) Patent Application Publication
(10) Pub. No.: US 2025/0294339 A1
(43) Pub. Date: Sep. 18, 2025

(54) TECHNIQUES FOR CONCURRENTLY MANAGING DIFFERENT CONTEXTS FOR ELECTRONIC SUBSCRIBER IDENTITY MODULES

(71) Applicant: Apple Inc., Cupertino, CA (US)

(72) Inventors: Hyewon LEE, Cupertino, CA (US); Aurelien P. RABOISSON, San Diego, CA (US); Jean-Marc PADOVA, San Francisco, CA (US); Ngabin S. NG, San Diego, CA (US); Xiangying YANG, Cupertino, CA (US)

(21) Appl. No.: 19/065,098

(22) Filed: Feb. 27, 2025

Related U.S. Application Data
(60) Provisional application No. 63/564,957, filed on Mar. 13, 2024.

(51) Int. Cl. H04W 8/18; H04W 8/20

(52) U.S. Cl. CPC H04W 8/183; H04W 8/20

(57) ABSTRACT

This application sets forth techniques for managing both consumer and Internet of Things (IoT) contexts relative to utilizing at least one consumer-related electronic Subscriber Identity Module (eSIM) and at least one IoT-related eSIM, respectively. According to some embodiments, the method can be implemented by a wireless device, and includes providing, to an embedded Universal Integrated Circuit Card (eUICC) included in the wireless device, a terminal capability command that indicates both the consumer and IoT contexts should be managed. In turn, the wireless device can provide function calls to the eUICC, where the function calls are accompanied with context information to indicate the context (i.e., consumer or IoT) under which the function calls should be processed. Additionally, the wireless device can provide context switch (i.e., consumer or IoT) commands to the eUICC, to cause the eUICC to utilize a particular context when processing function calls (until further notice is received).

### CROSS-REFERENCE TO RELATED APPLICATIONS

The present application claims the benefit of U.S. Provisional Application No. 63/564,957, entitled “TECHNIQUES FOR CONCURRENTLY MANAGING DIFFERENT CONTEXTS FOR ELECTRONIC SUBSCRIBER IDENTITY MODULES,” filed Mar. 13, 2024, the content of which is incorporated by reference herein in its entirety for all purposes.

### FIELD

The described embodiments set forth techniques for concurrently managing different contexts for electronic Subscriber Identity Modules (eSIMs). In particular, the techniques include managing both consumer and Internet of Things (IoT) contexts relative to utilizing at least one consumer-related electronic Subscriber Identity Module (eSIM) and at least one IoT-related eSIM, respectively.

### BACKGROUND

Many wireless devices are configured to use removable Universal Integrated Circuit Cards (UICCs) that enable the wireless devices to access services provided by Mobile Network Operators (MNOs). In particular, each UICC includes at least a microprocessor and a read-only memory (ROM), where the ROM is configured to store an MNO profile that the wireless device can use to register and interact with an MNO to obtain wireless services via a cellular wireless network. An MNO profile may also be referred to as Subscriber Identity Module (SIM). Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. More recently, integrated SIMs (iSIMs) have been proposed as a type of SIM that integrates directly into device hardware, e.g., a device processor and/or attached memory and/or a system on a chip (SoC) component, without use of a separate eUICC to store the iSIM.

In some cases, it may be desirable for eUICCs in certain devices—such as a vehicle—to provide consumer-related eSIM functionalities (e.g., phone calls, Internet access, etc.), and to also provide Internet of Things (IoT)-related eSIM functionalities (e.g., diagnostics reporting, location services, etc.). Unfortunately, under current approaches, a given eUICC is only able to manage a single context—i.e., a consumer context or an IoT context—while operating, thereby limiting the eUICC to providing only the consumer-related eSIM functionalities or the IoT-related functionalities, respectively, at a time. Moreover, transitioning between the different contexts requires a full reset of the eUICC, which leads to operating inefficiencies, communication outages, and so on. Accordingly, there is a need to improve how eUICCs manages different contexts so that consumer-related/IoT-related eSIM functionalities can be accessed in an efficient manner.

### SUMMARY

The described embodiments set forth techniques for concurrently managing different contexts for electronic Subscriber Identity Modules (eSIMs). In particular, the techniques include managing both consumer and Internet of Things (IoT) contexts relative to utilizing at least one consumer-related electronic Subscriber Identity Module (eSIM) and at least one IoT-related eSIM, respectively.

One embodiment sets forth a method for managing both consumer and Internet of Things (IoT) contexts relative to utilizing at least one consumer-related electronic Subscriber Identity Module (eSIM) and at least one IoT-related eSIM, respectively. According to some embodiments, the method can be implemented by a wireless device, and includes the steps of (1) providing, to an embedded Universal Integrated Circuit Card (eUICC) included in the wireless device, a terminal capability command that indicates both the consumer and IoT contexts should be managed, (2) providing, to the eUICC, at least one first function call that indicates the consumer context, wherein the consumer context causes the eUICC to, based on the consumer context and the at least one consumer-related eSIM, (i) process the at least one first function call, and (ii) provide at least one first response to the at least one first function call, and (3) providing, to the eUICC, at least one second function call that indicates the IoT context, wherein the IoT context causes the eUICC to, based on the IoT context and the at least one IoT-related eSIM, (i) process the at least one second function call, and (ii) provide at least one second response to the at least one second function call.

Another embodiment sets forth a method for managing both consumer and Internet of Things (IoT) contexts relative to utilizing at least one consumer-related electronic Subscriber Identity Module (eSIM) and at least one IoT-related eSIM, respectively. According to some embodiments, the method can be implemented by a wireless device, and includes the steps of (1) providing, to an embedded Universal Integrated Circuit Card (eUICC) included in the wireless device, a terminal capability command that indicates both the consumer and IoT contexts should be managed, (2) identifying at least one first condition under which to call at least one first function pertaining to the consumer context, (3) providing, to the eUICC, a consumer context switch command that causes the eUICC to, based on the consumer context and the at least one consumer-related eSIM, and until further notice is received, (i) process particular function calls including the first function call, and (ii) provide first responses to the particular function calls, (4) identifying at least one second condition under which to call at least one second function pertaining to the IoT context, (5) providing, to the eUICC, an IoT context switch command that causes the eUICC to, based on the IoT context and the at least one IoT-related eSIM, and until further notice is received, (i) process the particular function calls including the second function call, and (ii) provide second responses to the particular function calls.

Another embodiment sets forth a method for managing both consumer and Internet of Things (IoT) contexts relative to utilizing at least one consumer-related electronic Subscriber Identity Module (eSIM) and at least one IoT-related eSIM, respectively. According to some embodiments, the method can be implemented by an embedded Universal Integrated Circuit Card (eUICC), and includes the steps of (1) receiving, from a wireless device, a terminal capability command that indicates both the consumer and IoT contexts should be managed, (2) receiving, from the wireless device, at least one first function call that indicates the consumer context, (3) based on the consumer context and the at least one consumer-related eSIM, (i) process the at least one first function call, and (ii) provide, to the wireless device, at least one first response to the at least one first function call, (4) receiving, from the wireless device, at least one second function call that indicates the IoT context, and (5) based on the IoT context and the at least one IoT-related eSIM, (i) process the at least one second function call, and (ii) provide, to the wireless device, at least one second response to the at least one second function call.

Yet another embodiment sets forth a method for managing both consumer and Internet of Things (IoT) contexts relative to utilizing at least one consumer-related electronic Subscriber Identity Module (eSIM) and at least one IoT-related eSIM, respectively. According to some embodiments, the method can be implemented by an embedded Universal Integrated Circuit Card (eUICC), and includes the steps of (1) receiving, from a wireless device, a terminal capability command that indicates both the consumer and IoT contexts should be managed, (2) receiving, from the wireless device, a consumer context switch command, wherein the consumer context switch command is provided in response to the wireless device identifying at least one first condition under which to call at least one first function pertaining to the consumer context, (3) based on the consumer context and the at least one consumer-related eSIM, and until further notice is received, (i) processing particular function calls including the first function call, and (ii) providing first responses to the particular function calls, (4) receiving, from the wireless device, an IoT context switch command, wherein the IoT context switch command is provided in response to the wireless device identifying at least one second condition under which to call at least one second function pertaining to the IoT context, (5) based on the IoT context and the at least one IoT-related eSIM, and until further notice is received, (i) processing the particular function calls including the second function call, and (ii) providing second responses to the particular function calls.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2A illustrates a block diagram of a more detailed view of exemplary components of the system of FIG. 1, according to some embodiments.

FIG. 2B illustrates a conceptual diagram 250 of an exemplary system that can include any combination of different types of wireless devices that can support cellular wireless connectivity with support from various network-based servers to provide eSIMs for access to cellular wireless services for a wireless device, according to some embodiments.

FIG. 3 illustrates a conceptual diagram of example approaches for configuring an eUICC in accordance with a consumer terminal capability, an IoT terminal capability, or a hybrid terminal capability that includes both the consumer and IoT terminal capabilities, according to some embodiments.

FIG. 4 illustrates a sequence diagram of a technique for managing both consumer and Internet of Things (IoT) contexts relative to utilizing at least one consumer-related electronic Subscriber Identity Module (eSIM) and at least one IoT-related eSIM, respectively, according to some embodiments.

FIG. 5 illustrates a method for managing both consumer and Internet of Things (IoT) contexts relative to utilizing at least one consumer-related electronic Subscriber Identity Module (eSIM) and at least one IoT-related eSIM, respectively, according to some embodiments.

FIG. 6 illustrates another method for managing both consumer and Internet of Things (IoT) contexts relative to utilizing at least one consumer-related electronic Subscriber Identity Module (eSIM) and at least one IoT-related eSIM, respectively, according to some embodiments.

FIG. 7 illustrates another method for managing both consumer and Internet of Things (IoT) contexts relative to utilizing at least one consumer-related electronic Subscriber Identity Module (eSIM) and at least one IoT-related eSIM, respectively, according to some embodiments.

FIG. 8 illustrates yet another method for managing both consumer and Internet of Things (IoT) contexts relative to utilizing at least one consumer-related electronic Subscriber Identity Module (eSIM) and at least one IoT-related eSIM, respectively, according to some embodiments.

FIG. 9 illustrates a detailed view of a representative computing device that can be used to implement various methods described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments set forth techniques for concurrently managing different contexts for electronic Subscriber Identity Modules (eSIMs). In particular, the techniques include managing both consumer and Internet of Things (IoT) contexts relative to utilizing at least one consumer-related electronic Subscriber Identity Module (eSIM) and at least one IoT-related eSIM, respectively.

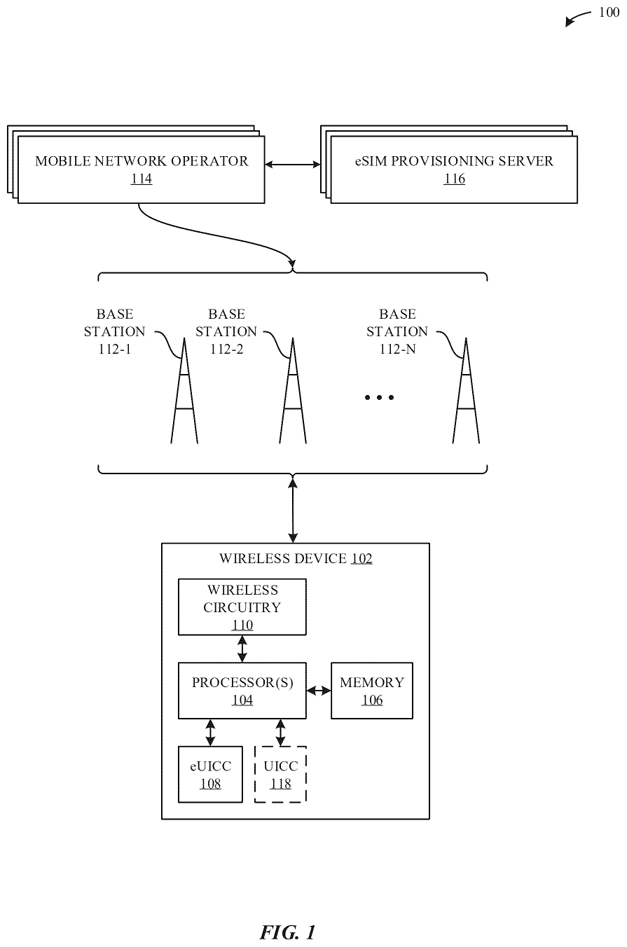

These and other embodiments are discussed below with reference to FIGS. 1-9. However, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a mobile wireless device, a mobile device, a user equipment (UE) and the like, a group of base stations 112-1 to 112-N that are managed by different Mobile Network Operators (MNOs) 114, and a set of eSIM provisioning servers 116 that are in communication with the MNOs 114. Additional MNO infrastructure servers, such as used for account management and billing are not shown. The wireless device 102 can represent, for example, a cellular-capable computing device (e.g., an iPhone® or an iPad® by Apple®), a cellular-capable wearable device (e.g., an Apple Watch), a cellular-capable vehicle, and the like. The base stations 112-1 to 112-n can represent cellular wireless network entities, including evolved NodeBs (eNodeBs or eNBs) for fourth generation (4G) long term evolution (LTE) wireless networks and/or next generation NodeBs (gNodeBs or gNB) for fifth generation (5G) wireless networks (or comparable nodes for future generation wireless networks), where the cellular wireless network entities are configured to communicate with the wireless device 102, and the MNOs 114 can represent different wireless service providers that provide specific cellular wireless services (e.g., voice and data) to which the wireless device 102 can subscribe.

As shown in FIG. 1, the wireless device 102 can include processing circuitry, which can include one or more processor(s) 104 and a memory 106, and wireless circuitry 110 used for transmission and reception of cellular wireless radio frequency signals. The wireless circuitry 110 can include analog hardware components, such as antennas and amplifiers, as well as digital processing components, such as signal processors (and/or general/limited purpose processors) and associated memory. In some embodiments, the wireless device 102 includes an embedded universal integrated circuit card (eUICC) 108 for storing one or more electronic SIMs (eSIMs). In some embodiments, the wireless device 102 includes (or is capable of including) one or more integrated SIMs (iSIMs) stored securely in hardware of the wireless device 102, e.g., in a processor (104), in memory (106), or in a system on a chip (SoC) component. In some embodiments, the wireless device 102 includes one or more physical UICCs 118, also referred to as Subscriber Identity Module (SIM) cards, in addition to or substituting for one or more eSIMs on the eUICC 108 or one or more iSIMs stored in hardware of the wireless device 102. The components of the wireless device 102 work together to enable the wireless device 102 to provide useful features to a user of the wireless device 102, such as cellular wireless network access, non-cellular wireless network access, localized computing, location-based services, and Internet connectivity.

According to some embodiments, the eUICC 108 can be configured to store multiple electronic SIMs (eSIMs) for accessing cellular wireless services provided by different MNOs 114 by connecting to their respective cellular wireless networks through a base station 112 (or via multiple base stations 112), such as one or more of the base stations 112-1 to 112-N illustrated. For example, the eUICC 108 can be configured to store and manage one or more eSIMs for one or more MNOs 114 for different cellular wireless service subscriptions to which the wireless device 102 is subscribed. To be able to access cellular wireless services provided by an MNO 114, can be eSIM reserved for download and installation to the eUICC 108. The eUICC 108 can store one or more eSIMs obtained from one or more associated eSIM provisioning servers 116. An eSIM provisioning server 116 can be maintained by a manufacturer of the wireless device 102, by an MNO 114, by a third-party entity, or the like. Communication of eSIM data between an eSIM provisioning server 116 and the eUICC 108 (or between the eSIM provisioning server 116 and processing circuitry of the wireless device 102 external to the eUICC 108, e.g., the processor 104) can use a secure communication channel. Similarly, one or more iSIMs can be stored securely in hardware of the wireless device 102 to enable access to cellular wireless services.

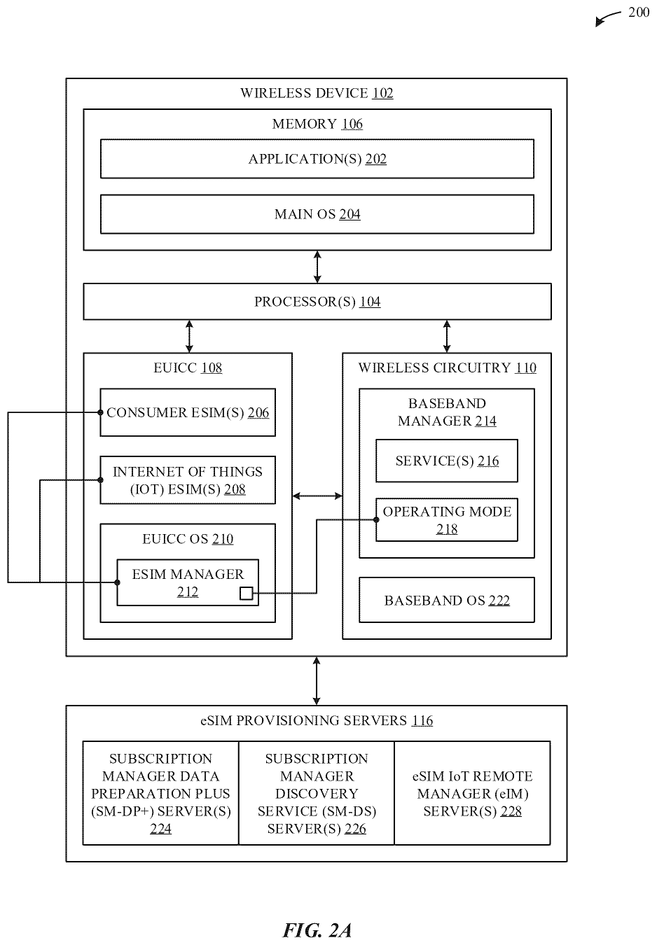

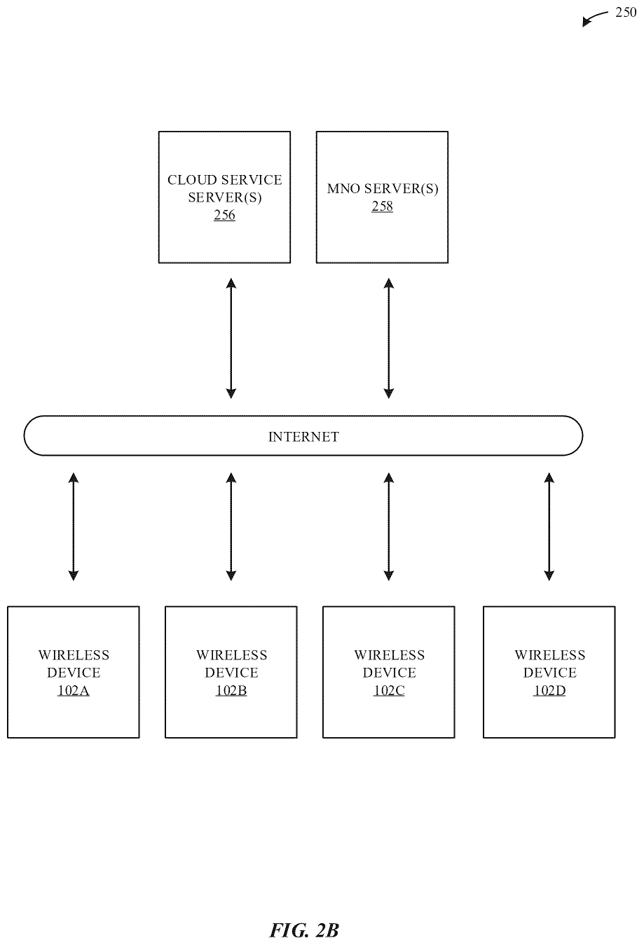

FIG. 2A illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 204 that is configured to execute applications 202 (e.g., native OS applications and user applications). As also shown in FIG. 2A, the eUICC 108 can be configured to implement an eUICC OS 210 that is configured to manage hardware resources of the eUICC 108 (e.g., a processor and a memory embedded in the eUICC 108). The eUICC OS 210 can also be configured to manage consumer-related eSIMs 206/Internet of Things (IoT)-related eSIMs 208 that are stored by the eUICC 108, e.g., by downloading, installing, deleting, enabling, disabling, modifying, or otherwise performing management of the eSIMs 206/208 within the eUICC 108 and providing wireless circuitry 110 with access to the eSIMs 206/208 to provide access to cellular wireless services for the wireless device 102. The eUICC 108 OS can include an eSIM manager 212, which can perform management functions for the eSIMs 206/208. According to some embodiments, each eSIM 206/208 can include a number of applets (not illustrated in FIG. 2A) that define the manner in which the eSIM 206/208 operates. For example, one or more of the applets, when implemented in conjunction with wireless circuitry 110 and the eUICC 108, can be configured to enable the wireless device 102 to communicate with an MNO 114 and provide useful features (e.g., phone call and Internet access capabilities) to the wireless device 102.

As also shown in FIG. 2A, the wireless circuitry 110 of the wireless device 102 can include a baseband OS 222 that is configured to manage hardware resources of the wireless circuitry 110 (e.g., a processor, a memory, different radio components, etc.). According to some embodiments, the wireless circuitry 110 can implement a baseband manager 214 that is configured to interface with the eUICC 108 to establish a secure channel with an eSIM provisioning server 116 and obtain information (such eSIMs 206/208) from the eSIM provisioning servers 116. As shown in FIG. 2A, the eSIM provisioning servers 116 can include subscription manager data preparation plus (SM-DP+) servers 224 (e.g., configured to provide consumer-related eSIMs), subscription manager discovery service (SM-DS) servers 226 (e.g., configured to perform eSIM management functionalities), and eSIM IoT remote manager (eIM) servers 228 (configured to provide IoT-related eSIMs).

According to some embodiments, the baseband manager 214 can be configured to implement services 216, which represents a collection of software modules that are instantiated by way of the various applets of enabled eSIMs 206/208 that are included in the eUICC 108 in the wireless device 102. For example, services 216 can be configured to manage different connections between the wireless device 102 and MNOs 114 according to the different eSIMs 206/208 that are enabled within the eUICC 108. According to some embodiments, the baseband manager 214/eSIM manager 212 can also be configured to manage an operating mode 218 that reflects whether (only) a consumer context is active (for managing consumer-related eSIMs 206), whether (only) an IoT context is active (for managing IoT-related eSIMs 208), or whether both the consumer context and the IoT context are concurrently active (referred to herein as a hybrid terminal capability/operating mode). It is noted that the operating mode 218 is not limited to the consumer and IoT contexts described herein. On the contrary, the baseband manager 214 can be configured to manage any number of contexts—as well as different types of eSIMs that correspond to the contexts—consistent with the scope of this disclosure.

Additionally, for one or more iSIMs embedded directly in hardware of the wireless device 102, e.g., in a processor 104, memory 106, or an SoC (not shown), the one or more iSIMs can contain modules that provide similar functionality as those illustrated for eSIMs 206/208, and supporting eSIM software/firmware, such as the eSIM manager 212 and eUICC OS 210, can be provided by similar software/firmware elements in the hardware of the wireless device 102 in which the one or more iSIMs are stored.

FIG. 2B illustrates a conceptual diagram 250 of an exemplary system that can include any combination of different types of wireless devices 102 that can support cellular wireless connectivity with support from various network-based servers to provide eSIMs for access to cellular wireless services for a wireless device 102, according to some embodiments. Different types of wireless devices 102 can include a cellular-capable mobile phone 102A, a cellular-capable wearable device 102B, a cellular-capable tablet computer 102C, and a cellular-capable vehicle 102D. It is noted that the foregoing examples are not meant to be limiting, and that the wireless device 102 can represent, be included in, etc., any physical entity, consistent with the scope of this disclosure. Cellular capability for the wireless devices 102A-102D can be based on SIM cards (UICCs 118), eSIMs 208 included on eUICCs 108, on iSIMs, and so on.

In some cases, the wireless devices 102A, 102B, 102C, and 102D can each be associated with a common user account, e.g., a cloud-based service account, such as an iCloud® account that is network accessible to the wireless devices 102 via Internet data connections to one or more cloud service servers 256. Data for a wireless device 102A, 102B, 102C, and 102D can be stored securely in the cloud-based service account on one or more cloud service servers 256, which in some cases can be used to transfer information between different wireless devices 102. For example, a use can replace an older wireless device 102 with a newer wireless device 102 and seek to transfer various information, settings, preferences and the like from the older wireless device 102 to the newer wireless device 102. Additionally, habitual device usage characteristics collated and determined by the older wireless device 102 can be transferred to the newer wireless device 102, either directly in a peer-to-peer transfer or via backup and restore through local storage or via remote storage on the one or more cloud service servers 256. The habitual device usage characteristics can be encrypted before transfer via remote storage to preserve user privacy before loading to the newer wireless device 102.

An MNO 114 can provide cellular wireless services to the set of wireless devices 102 and can manage access to cellular wireless networks to access the cellular wireless services offered by the MNO 114 for a particular cellular wireless service subscription (or for a set of cellular wireless service subscriptions) via one or more MNO servers 258. The MNO servers 258 can include one or more provisioning servers 116 for providing eSIMs 208 (and/or iSIMs) to wireless devices 102. One or more SIMs (e.g., eSIMs 208 and/or iSIMs) can be provided to a wireless device 102 based on a variety of factors. For example, when the wireless device 102A represents a user's smartphone, it may be sufficient for a single SIM to be provided to the wireless device 102A to enable the user to access wireless services through the wireless device 102A. In another example, when the wireless device 102D represents the user's vehicle, it may be appropriate to provide, to the vehicle, (1) a consumer-related SIM to enable the user to place phone calls, access the internet, etc., through the vehicle, and (2) an IoT-related SIM to enable the vehicle to interface with a management entity (e.g., a manufacturer of the vehicle) to provide diagnostics, receive software updates, and so on.

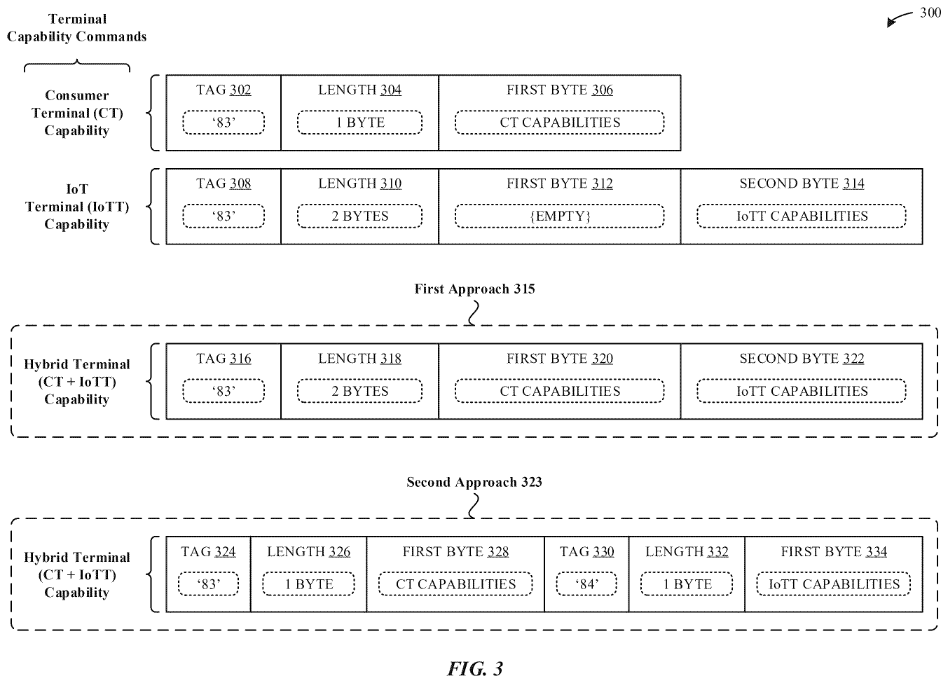

FIG. 3 illustrates a conceptual diagram 300 of example approaches for configuring an eUICC 108 in accordance with a consumer terminal capability, an IoT terminal capability, or a hybrid terminal capability that includes both the consumer and IoT terminal capabilities, according to some embodiments. According to some embodiments, the wireless circuitry 110/wireless device 102 can, in association with being powered-on, reset, etc., send a terminal capability command to the eUICC 108 to cause the eUICC 108 to enter into one of the operating modes 218 described above in conjunction with FIG. 2A. According to some embodiments, the terminal capability command described herein may be a TERMINAL CAPABILITY command as described in ETSI TS 102 221. According to some embodiments, and as described below in greater detail, the terminal capability command can include, be accompanied by, etc., information that indicates the appropriate operating mode 218, properties that should apply to the operating mode 218, and so on.

As shown in FIG. 3, one example approach for causing the eUICC 108 to configure itself in accordance with the consumer terminal capability can involve the wireless device 102 transmitting, to the eUICC 108, a tag-length-value (TLV) package that includes a tag 302 (indicating a value of ‘83’), a length 304 (indicating one byte), and a first byte 306 (indicating detailed properties that pertain to the consumer terminal capability). As also shown in FIG. 3, one example approach for causing the eUICC 108 to configure itself in accordance with the IoT terminal capability can involve the wireless device 102 transmitting, to the eUICC 108, a TLV package that includes a tag 308 (indicating a value of ‘83’), a length 310 (indicating two bytes), a first byte 312 (that is empty (e.g., all values set to zero)), and a second byte 314 (indicating detailed properties that pertain to the IoT terminal capability).

Additionally, FIG. 3 illustrates two example approaches that can be used to cause the eUICC 108 to configured itself in accordance with the hybrid terminal capability. In particular, a first approach 315 can involve the wireless device 102 transmitting, to the eUICC 108, a TLV package that includes a tag 316 (indicating a value of ‘83’), a length 318 (indicating two bytes), a first byte 320 (indicating detailed properties that pertain to the consumer terminal capability), and a second byte 322 (indicating detailed properties that pertain to the IoT terminal capability). A second approach 323 can involve the wireless device 102 transmitting, to the eUICC 108, a first TLV package that includes a tag 324 (indicating a value of ‘83’), a length 326 (indicating one byte), and a first byte 328 (indicating detailed properties that pertain to the consumer terminal capability), along with a second TLV package that includes a tag 330 (indicating a value of ‘84’), a length 332 (indicating one byte), and a first byte 334 (indicating detailed properties that pertain to the IoT terminal capability). It is noted that the foregoing examples are not meant to be limiting, and that the wireless device 102/eUICC 108 can be configured to communicate any amount, type, form, etc., of information to effectively convey the operating mode 218 that should be utilized, configurational aspects of the operating mode 218, and so on, consistent with the scope of this disclosure.

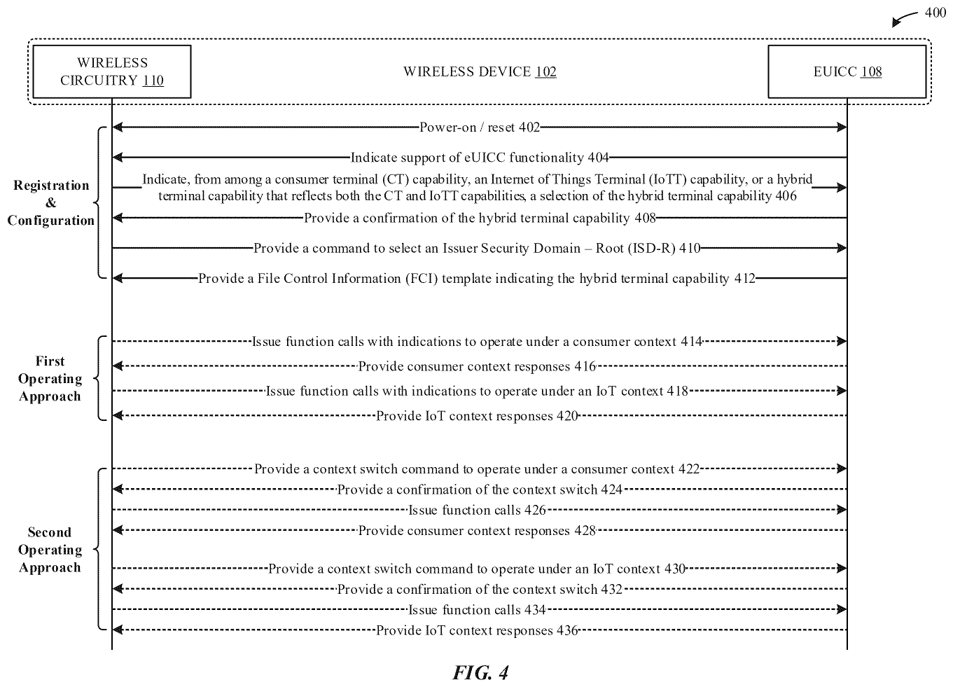

FIG. 4 illustrates a sequence diagram 400 of a technique for managing both consumer and Internet of Things (IoT) contexts relative to utilizing at least one consumer-related electronic Subscriber Identity Module (eSIM) and at least one IoT-related eSIM, respectively, according to some embodiments. As shown in FIG. 4, at step 402, the wireless device 102 is powered-on, undergoes a reset process, or the like.

At step 404, the eUICC 108 indicates, to the wireless circuitry 110, that the eUICC 108 supports eUICC functionalities. According to some embodiments, the eUICC 108 can indicate its support of eUICC functionalities using an Answer To Reset (ATR) Global Interface byte as defined in ETSI TS 102 221. It should be appreciated that additional/alternative approaches can be utilized to effectively enable the eUICC 108 to indicate its support of eUICC functionalities, consistent with the scope of this disclosure.

At step 406, the wireless circuitry 110 indicates (to the eUICC 108), from among a consumer terminal (CT) capability, an Internet of Things terminal (IoTT) capability, or a hybrid terminal capability that reflects both the CT and IoTT capabilities, a selection of the hybrid terminal capability. According to some embodiments, the wireless circuitry 110 can provide the indication to the eUICC 108 using the first approach 315 described above in conjunction with FIG. 3, using the second approach 323 described above in conjunction with FIG. 3, or any other approach that effectively enables the wireless circuitry 110 to indicate that the eUICC 108 should implement the hybrid terminal capability.

At step 408, the eUICC 108 provides, to the wireless circuitry 110, a confirmation of the hybrid terminal capability. According to some embodiments, the confirmation can be provided in the form of a Status Word (SW) with status bytes set to the value “90 00” to effectively indicate that the hybrid terminal capability is confirmed by the eUICC 108. It should be appreciated that additional/alternative approaches can be utilized to effectively enable eUICC 108 to provide, to the wireless circuitry 110, a confirmation of the hybrid terminal capability, consistent with the scope of this disclosure.

At step 410, the wireless circuitry 110 provides, to the eUICC 108, a command to select an Issuer Security Domain-Root (ISD-R). According to some embodiments, the command can be transmitted through a logical channel that is established between the wireless circuitry 110 and the eUICC 108 using the MANAGE CHANNEL command defined in the GlobalPlatform Card Specification. According to some embodiments, the command can be established, formatted, etc., using the SELECT command defined in the GlobalPlatform Card Specification. It should be appreciated that additional/alternative approaches can be utilized to effectively enable the wireless circuitry 110 to provide, to the eUICC 108, a command to select the ISD-R, consistent with the scope of this disclosure.

At step 412, the wireless circuitry 110 provides a File Control Information (FCI) template indicating the hybrid terminal capability. According to some embodiments, the FCI template can include tags “A0” and “A1” to indicate the hybrid terminal capability, where “A0” corresponds to consumer-related capabilities, and “A1” corresponds to IoT-related capabilities. It should be appreciated that additional/alternative approaches can be utilized to effectively enable the wireless circuitry 110 to provide, to the eUICC 108, an indication of the hybrid terminal capability (e.g., additional/alternative templates, commands, tags, etc.).

At the conclusion of step 412, the wireless circuitry 110 and the eUICC 108 are configured in accordance with the hybrid operating mode described herein. In this regard, the wireless circuitry 110 and the eUICC 108 can effectively manage consumer and IoT contexts when utilizing consumer-related eSIMs and IoT-related eSIMs, respectively. Different approaches can be utilized to manage these contexts, according to some embodiments. In particular, a first operating approach—which includes steps 414-420, described below in conjunction with FIG. 4—involves accompanying function calls with tags that identify whether the consumer context or the IoT context should apply when processing the function calls. A second operating approach—which includes steps 422-436, described below in conjunction with FIG. 4—involves providing context switch commands each time a transition should be made from applying the consumer context to applying the IoT context (or vice-versa). It should be understood that additional/alternative approaches can be utilized to effectively enable the wireless circuitry 110/the eUICC 108 to select, identify, apply, etc., the appropriate context when processing function calls, consistent with the scope of this disclosure.

Under the first approach, at step 414, the wireless circuitry 110 issues function calls with indications to operate under a consumer context. The function calls can represent, for example, ES10 function calls defined in the GSMA RSP Technical Specification, eSIM IoT Technical Specification, and the like. It is noted that the foregoing examples are not meant to be limiting, and that the function calls can include any type, form, etc., of function call, at any level of granularity, consistent with the scope of this disclosure. According to some embodiments, each function call can include, be accompanied by, etc., a respective tag that identifies the context that should apply when processing the function call, e.g., the tag “A0” (where “A0” corresponds to the consumer context). It should be appreciated that additional/alternative approaches can be utilized to effectively enable the wireless circuitry 110 to indicate that the eUICC 108 should apply the consumer context when processing the function calls, consistent with the scope of this disclosure.

At step 416, the wireless circuitry 110 provides consumer context responses (in response to the function calls provided in step 414). According to some embodiments, each consumer context response can optionally include, be accompanied by, etc., the tag “A0” to confirm, indicate to the wireless circuitry 110, etc., that the consumer context was applied when processing the consumer context response. In any case, the wireless circuitry 110 can process the consumer context responses as appropriate.

At step 418, the wireless circuitry 110 issues function calls with indications to operate under an IoT context. As described herein, the function calls can represent, for example, ES10 function calls defined in the GSMA RSP Technical Specification, eSIM IoT Technical Specification, and the like. According to some embodiments, each function call can include, be accompanied by, etc., a respective tag that identifies the context that should apply when processing the function call, e.g., the tag “A1” (where “A1” corresponds to the IoT context). It should be appreciated that additional/alternative approaches can be utilized to effectively enable the wireless circuitry 110 to indicate that the eUICC 108 should apply the IoT context when processing the function calls, consistent with the scope of this disclosure.

At step 420, the wireless circuitry 110 provides IoT context responses. As described herein, each IoT context response can optionally include, be accompanied by, etc., the tag “A1” to confirm, indicate to the wireless circuitry 110, etc., that the IoT context was applied when processing the IoT context response. In any case, the wireless circuitry 110 can process the IoT context responses as appropriate.

Under the second approach, context switch commands are utilized instead of (or in addition to) the foregoing approach that involves accompanying function calls with tags that identify respective contexts that should be applied when processing the function calls. In particular, and according to some embodiments, a given context switch command can include a respective tag that identifies that context that should be applied against function calls until further notice is received—that is, until a subsequent context switch command that specifies a different context is received. For example, when one or more function calls (that need to be processed) are associated with the consumer context, the wireless circuitry 110 can provide a context switch command that includes, is accompanied by, etc., the tag “A0” to convey that the consumer context should be applied until further notice is received. In another example, when one or more function calls (that need to be processed) are associated with the IoT context, the wireless circuitry 110 can provide a context switch command that includes, is accompanied by, etc., the tag “A1” to convey that the consumer context should be applied until further notice is received. It should be appreciated that additional/alternative approaches can be utilized to effectively enable the wireless circuitry 110 to indicate to the eUICC 108 that a particular context should be applied to subsequent function calls until further notice is received, consistent with the scope of this disclosure.

To illustrate the second approach, at step 422, the wireless circuitry 110 provides, to the eUICC 108, a context switch command to operate under a consumer context. The context switch command can be provided, for example, in response to the wireless circuitry 110 identifying a need, a condition, etc., to issue one or more function calls that pertain to the consumer context. Again, the function calls can represent, for example, ES10 function calls defined in the GSMA RSP Technical Specification, eSIM IoT Technical Specification, and the like. At step 424, the wireless circuitry 110 provides a confirmation of the context switch (e.g., in accordance with the techniques described above in conjunction with step 408). This confirmation can indicate to the wireless circuitry 110 that the eUICC 108 has been properly configured and is ready to process the function calls using the consumer context. In turn, at step 426, the wireless circuitry 110 issues the function calls to the eUICC 108, and, at step 428, the eUICC 108 provides consumer context responses to the wireless circuitry 110.

Additionally, to illustrate the second approach, at step 430, the wireless circuitry 110 provides a context switch command to operate under an IoT context. The context switch command can be provided, for example, in response to the wireless circuitry 110 identifying a need, a condition, etc., to issue one or more function calls that pertain to the IoT context. At step 432, the wireless circuitry 110 provides a confirmation of the context switch (e.g., in accordance with the techniques described above in conjunction with steps 408 and 424). This confirmation can indicate to the wireless circuitry 110 that the eUICC 108 has been properly configured and is ready to process the function calls using the IoT context. In turn, at step 434, the wireless circuitry 110 issues the function calls to the eUICC 108, and, at step 436, the eUICC 108 provides IoT context responses to the wireless circuitry 110.

Accordingly, the first approach described in FIG. 4 can be more efficient (relative to the second approach) when function calls pertaining to different (i.e., varying) contexts are frequently interleaved-which, under the second approach, would require context switch commands to be frequently issued, and thereby result in thrashing scenarios. Conversely, the second approach described in FIG. 4 can be more efficient (relative to the first approach) when function calls pertaining to different contexts are infrequently interleaved-which, under the first approach, would involve function calls being, in effect, unnecessarily accompanied by tag information (e.g., when a majority/group of function calls are directed to the consumer context and a minority/group of function calls are directed to the IoT context, or vice-versa).

To mitigate the foregoing deficiencies, the wireless circuitry 110 can be configured to monitor, analyze, etc., the manner in which function calls are being issued, will be issued, etc., the contexts to which they apply, and so on, to identify when it is most beneficial to utilize the first operating approach, and when it is most beneficial to utilize the second operating approach. In this regard, the wireless circuitry 110 can be configured to issue, to the eUICC 108, operating mode switch commands (not illustrated in FIG. 4) to effectively cause the eUICC 108 to reconfigure itself to process the function calls in accordance with the first or second approach. Additionally, when the second approach is utilized, the wireless circuitry 110 can be configured to group pending (i.e., yet-to-be processed) function calls that correspond to the same context, and then issue a context switch command prior to issuing the subsequent/different group of function calls to be processed.

It should be understood that additional approaches can be utilized to apply appropriate contexts in relation to processing function calls. For example, the wireless circuitry 110/eUICC 108 can be configured to assume that function calls that do not specifically reference a context (e.g., using a tag) should be processed using the consumer context, whereas function calls that specifically reference the IoT context (e.g., using a tag that corresponds to the IoT context) should be processed using the IoT context (or vice-versa). Again, these approaches are exemplary, and any approach can be implemented that effectively enables the wireless circuitry 110/eUICC 108 to apply the appropriate context when processing function calls, consistent with the scope of this disclosure.

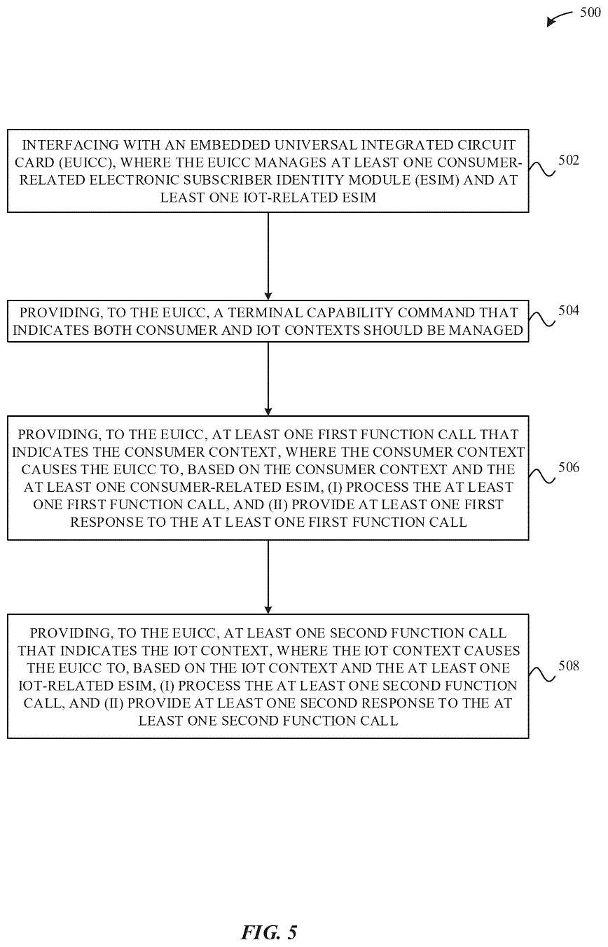

FIG. 5 illustrates a method 500 for managing both consumer and Internet of Things (IoT) contexts relative to utilizing at least one consumer-related electronic Subscriber Identity Module (eSIM) and at least one IoT-related eSIM, respectively, according to some embodiments. In some embodiments, the method 500 is performed by a wireless device 102, by one or more elements of a wireless device 102, such as one or more hardware components and/or one or more software/firmware modules, or by an apparatus configurable (or configured) for operation in a wireless device 102. In some embodiments, the method 500 is performed by an application processor and/or by a baseband processor of a wireless device 102. As shown in FIG. 5, the method 500, at step 502, includes interfacing with an embedded universal integrated circuit card (eUICC) 108, and where the eUICC 108 manages the at least one consumer-related eSIM and the at least one IoT-related eSIM. In some embodiments, the eUICC 108 is included in a wireless device 102. At step 504, the method 500 includes providing, to the eUICC 108, a terminal capability command that indicates both consumer and IoT contexts should be managed.

At step 506, the method includes providing, to the eUICC 108, at least one first function call that indicates the consumer context, where the consumer context causes the eUICC 108 to, based on the consumer context and the at least one consumer-related eSIM, (i) process the at least one first function call, and (ii) provide at least one first response to the at least one first function call.

At step 508, the method includes providing, to the eUICC 108, at least one second function call that indicates the IoT context, where the IoT context causes the eUICC 108 to, based on the IoT context and the at least one IoT-related eSIM, (i) process the at least one second function call, and (ii) provide at least one second response to the at least one second function call.

In some embodiments, the method 500 further includes receiving, from the eUICC 108 prior to providing the terminal capability command, an indication that the eUICC 108 supports eUICC 108 functionalities. In some embodiments, the terminal capability command is provided in response to an Answer-To-Reset (ATR) triggered by a power-on event or a reset event. In some embodiments, the method 500 further includes receiving, from the eUICC 108 in response to the terminal capability command, a confirmation that the eUICC 108 is managing both the consumer and IoT contexts. In some embodiments, the method 500 further includes: i) providing, to the eUICC 108, an Issuer Security Domain-Root (ISD-R) selection command, and ii) receiving, from the eUICC 108, a File Control Information (FCI) template that indicates both the consumer and IoT contexts. In some embodiments, the terminal capability command includes a tag-length-value (TLV) package, and the TLV package includes first and second bytes that identify at least one consumer-related functionality and at least one IoT-related functionality, respectively. In some embodiments, the terminal capability command includes first and second TLV packages, the first TLV package includes one byte that identifies at least one consumer-related functionality implemented by a wireless device 102, and the second TLV package includes one byte that identifies at least one IoT-related functionality. In some embodiments, the at least one consumer-related functionality and the at least one IoT-related functionality are implemented by a wireless device 102, by one or more elements of a wireless device 102, such as one or more hardware components and/or one or more software/firmware modules, or by an apparatus configurable (or configured) for operation in a wireless device 102.

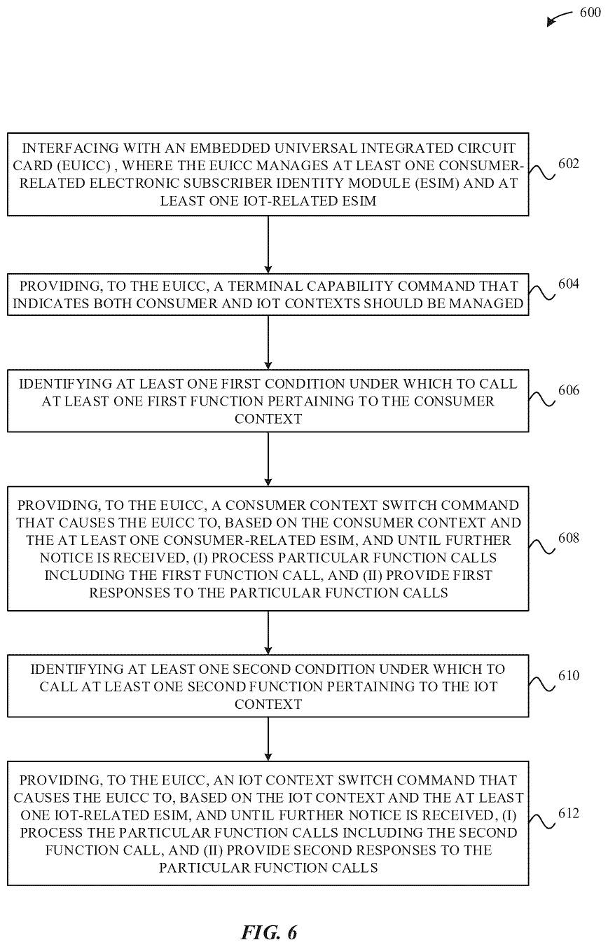

FIG. 6 illustrates a method 600 for managing both consumer and Internet of Things (IoT) contexts relative to utilizing at least one consumer-related electronic Subscriber Identity Module (eSIM) and at least one IoT-related eSIM, respectively, according to some embodiments. In some embodiments, the method 600 is performed by a wireless device 102, by one or more elements of a wireless device 102, such as one or more hardware components and/or one or more software/firmware modules, or by an apparatus configurable (or configured) for operation in a wireless device 102. In some embodiments, the method 600 is performed by an application processor and/or by a baseband processor of a wireless device 102. As shown in FIG. 6, the method 600, at step 602, includes interfacing with an embedded universal integrated circuit card (eUICC) 108, where the eUICC 108 manages the at least one consumer-related eSIM and the at least one IoT-related eSIM. In some embodiments, the eUICC 108 is included in a wireless device 102. At step 604, the method 600 includes providing, to the eUICC 108, a terminal capability command that indicates both consumer and IoT contexts should be managed.

At step 606, the method includes identifying at least one first condition under which to call at least one first function pertaining to the consumer context. At step 608, the method includes providing, to the eUICC 108, a consumer context switch command that causes the eUICC 108 to, based on the consumer context and the at least one consumer-related eSIM, and until further notice is received, (i) process particular function calls including the first function call, and (ii) provide first responses to the particular function calls.

At step 610, the method includes identifying at least one second condition under which to call at least one second function pertaining to the IoT context. At step 612, the method includes providing, to the eUICC 108, an IoT context switch command that causes the eUICC 108 to, based on the IoT context and the at least one IoT-related eSIM, and until further notice is received, (i) process the particular function calls including the second function call, and (ii) provide second responses to the particular function calls.

In some embodiments, the actions of steps 606 and 610 can be combined, e.g., i) identifying at least one first condition under which to call at least one first function pertaining to the consumer context and/or ii) identifying at least one second condition under which to call at least one second function pertaining to the IoT context. Additionally, in some embodiments, the actions of steps 608 and 612 can be combined, e.g., i) providing, to the eUICC 108, a consumer context switch command that causes the eUICC 108 to, based on the consumer context and the at least one consumer-related eSIM, and until further notice is received, (a) process particular function calls including the first function call, and (b) provide first responses to the particular function calls; and/or ii) providing, to the eUICC 108, an IoT context switch command that causes the eUICC 108 to, based on the IoT context and the at least one IoT-related eSIM, and until further notice is received, (a) process the particular function calls including the second function call, and (b) provide second responses to the particular function calls.

In some embodiments, the method 600 further includes receiving, from the eUICC 108 prior to providing the terminal capability command, an indication that the eUICC 108 supports eUICC 108 functionalities. In some embodiments, the terminal capability command is provided in response to an Answer-To-Reset (ATR) triggered by a power-on event or a reset event. In some embodiments, the method 600 further includes receiving, from the eUICC 108 in response to the terminal capability command, a confirmation that the eUICC 108 is managing both the consumer and IoT contexts. In some embodiments, the method 600 further includes: i) providing, to the eUICC 108, an ISD-R selection command; and ii) receiving, from the eUICC 108, an FCI template that indicates both the consumer and IoT contexts. In some embodiments, the terminal capability command includes a TLV package, and the TLV package includes first and second bytes that identify at least one consumer-related functionality and at least one IoT-related functionality, respectively. In some embodiments, the terminal capability command includes first and second TLV packages, the first TLV package includes one byte that identifies at least one consumer-related functionality, and the second TLV package includes one byte that identifies at least one IoT-related functionality. In some embodiments, the at least one consumer-related functionality and the at least one IoT-related functionality are implemented by a wireless device 102, by one or more elements of a wireless device 102, such as one or more hardware components and/or one or more software/firmware modules, or by an apparatus configurable (or configured) for operation in a wireless device 102.

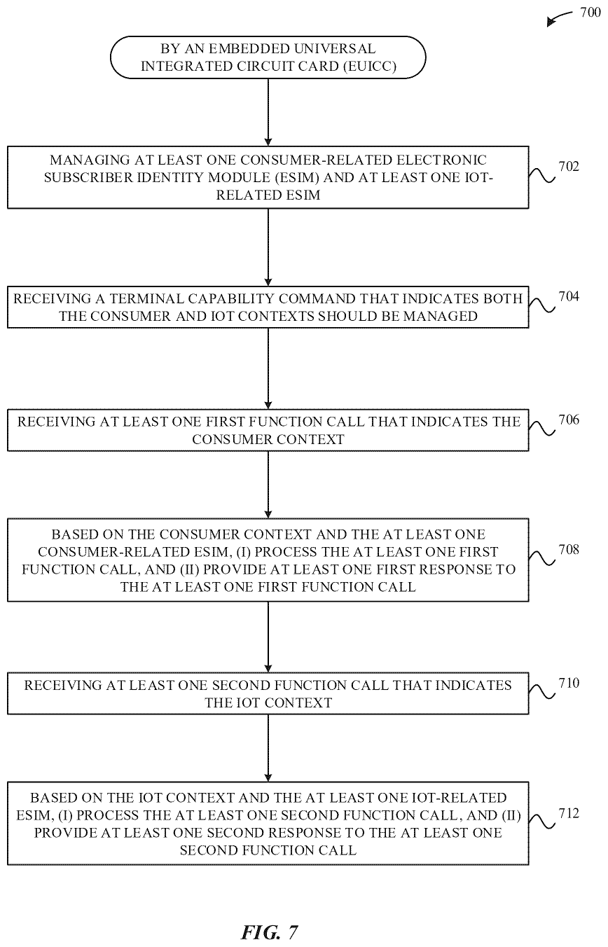

FIG. 7 illustrates a method 700 for managing both consumer and Internet of Things (IoT) contexts relative to utilizing at least one consumer-related electronic Subscriber Identity Module (eSIM) and at least one IoT-related eSIM, respectively, according to some embodiments. In some embodiments, the method 700 is performed by an eUICC 108 in communication with one or more elements of a wireless device 102, e.g., hardware components and/or software/firmware modules and/or an apparatus configurable (or configured) for operation in a wireless device 102. In some embodiments, the eUICC 108 communicates with an application processor and/or with a baseband processor of a wireless device 102. As shown in FIG. 7, the method 700 begins at step 702, where the eUICC 108 manages the at least one consumer-related eSIM and the at least one IoT-related eSIM. At step 704, the eUICC 108 receives a terminal capability command that indicates both the consumer and IoT contexts should be managed.

At step 706, the eUICC 108 receives at least one first function call that indicates the consumer context. At step 708, the eUICC 108, based on the consumer context and the at least one consumer-related eSIM, (i) processes the at least one first function call, and (ii) provides at least one first response to the at least one first function call.

At step 710, the eUICC 108 receives at least one second function call that indicates the IoT context. At step 712, the eUICC 108, based on the IoT context and the at least one IoT-related eSIM, (i) processes the at least one second function call, and (ii) provides at least one second response to the at least one second function call.

In some embodiments, the method 700 further includes the eUICC 108 providing, prior to receiving the terminal capability command, an indication that the eUICC 108 supports eUICC functionalities. In some embodiments, the terminal capability command is communicated by at least one of an application processor or a baseband processor, and the application processor is provided in response to an ATR triggered by a power-on event or a reset event. In some embodiments, the method 700 further includes the eUICC 108 providing, in response to the terminal capability command, a confirmation that both the consumer and IoT contexts are being managed. In some embodiments, the method 700 further includes the eUICC 108: i) receiving an ISD-R selection command; and ii) providing an FCI template that indicates both the consumer and IoT contexts. In some embodiments, the terminal capability command includes a TLV package, and the TLV package includes first and second bytes that identify at least one consumer-related functionality and at least one IoT-related functionality, respectively. In some embodiments, the terminal capability command includes first and second TLV packages, the first TLV package includes one byte that identifies at least one consumer-related functionality and the second TLV package includes one byte that identifies at least one IoT-related functionality. In some embodiments, the at least one consumer-related functionality and the at least one IoT-related functionality are implemented by a wireless device 102, by one or more elements of a wireless device 102, such as one or more hardware components and/or one or more software/firmware modules, or by an apparatus configurable (or configured) for operation in a wireless device 102.

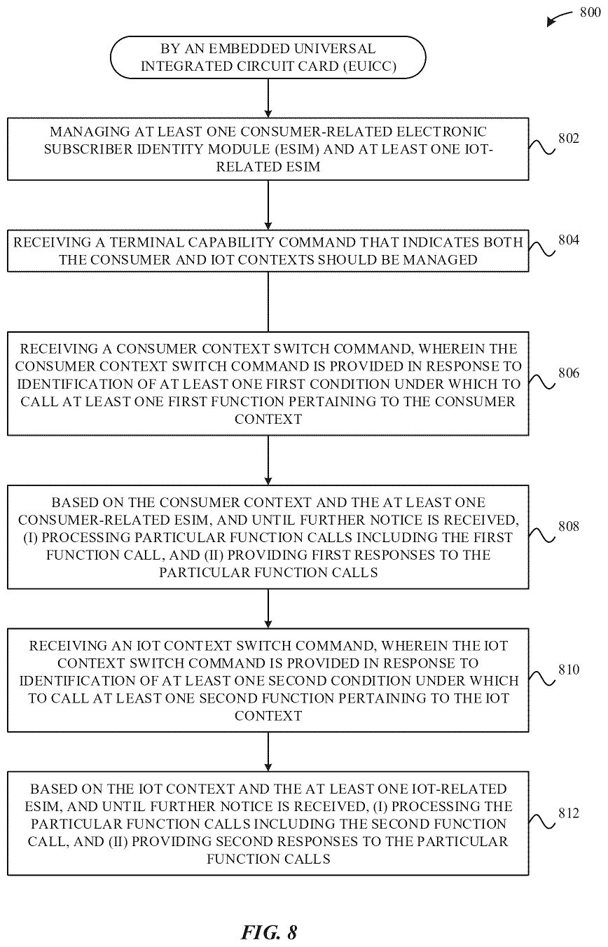

FIG. 8 illustrates a method 800 for managing both consumer and Internet of Things (IoT) contexts relative to utilizing at least one consumer-related electronic Subscriber Identity Module (eSIM) and at least one IoT-related eSIM, respectively, according to some embodiments. In some embodiments, the method 800 is performed by an eUICC 108 in communication with one or more elements of a wireless device 102, e.g., hardware components and/or software/firmware modules and/or an apparatus configurable (or configured) for operation in a wireless device 102. In some embodiments, the eUICC 108 communicates with an application processor and/or with a baseband processor of a wireless device 102. As shown in FIG. 8, the method 800 begins at step 802, where an eUICC 108 manages the at least one consumer-related eSIM and the at least one IoT-related eSIM. At step 804, the eUICC 108 receives a terminal capability command that indicates both the consumer and IoT contexts should be managed.

At step 806, the eUICC 108 receives a consumer context switch command, wherein the consumer context switch command is provided in response identification of at least one first condition under which to call at least one first function pertaining to the consumer context. In some embodiments, identification of the at least one first condition under which to call the at least one first function pertaining to the consumer context is performed by one or more elements of a wireless device 102, e.g., hardware components and/or software/firmware modules and/or an apparatus configurable (or configured) for operation in a wireless device 102. In some embodiments, identification of the at least one first condition under which to call the at least one first function pertaining to the consumer context is performed by one or more of an application processor or a baseband processor. At step 808, the eUICC 108, based on the consumer context and the at least one consumer-related eSIM, and until further notice is received, (i) processes particular function calls including the first function call, and (ii) provides first responses to the particular function calls.

At step 810, the eUICC 108 receives an IoT context switch command, wherein the IoT context switch command is provided in response to identification of at least one second condition under which to call at least one second function pertaining to the IoT context. In some embodiments, identification of the at least one second condition under which to call the at least one second function pertaining to the IoT context is performed by one or more elements of a wireless device 102, e.g., hardware components and/or software/firmware modules and/or an apparatus configurable (or configured) for operation in a wireless device 102. In some embodiments, identification of the at least one second condition under which to call the at least one second function pertaining to the IoT context is performed by one or more of an application processor or a baseband processor. At step 812, the eUICC 108, based on the IoT context and the at least one IoT-related eSIM, and until further notice is received, (i) processes the particular function calls including the second function call, and (ii) provides second responses to the particular function calls.

In some embodiments, the method 800 further includes the eUICC 108 providing, prior to receiving the terminal capability command, an indication that the eUICC 108 supports eUICC 108 functionalities. In some embodiments, the terminal capability command is communicated by at least one of an application processor or a baseband processor, and the application processor is provided in response to an ATR triggered by a power-on event or a reset event. In some embodiments, the method 800 further includes the eUICC 108 providing, in response to the terminal capability command, a confirmation that both the consumer and IoT contexts are being managed. In some embodiments, the method 800 further includes the eUICC 108: i) receiving an ISD-R selection command, and ii) providing an FCI template that indicates both the consumer and IoT contexts. In some embodiments, terminal capability command includes a TLV package, and the TLV package includes first and second bytes that identify at least one consumer-related functionality and at least one IoT-related functionality, respectively. In some embodiments, the terminal capability command includes first and second TLV packages, the first TLV package includes one byte that identifies at least one consumer-related functionality, and the second TLV package includes one byte that identifies at least one IoT-related functionality. In some embodiments, the at least one consumer-related functionality and the at least one IoT-related functionality are implemented by a wireless device 102, by one or more elements of a wireless device 102, such as one or more hardware components and/or one or more software/firmware modules, or by an apparatus configurable (or configured) for operation in a wireless device 102.

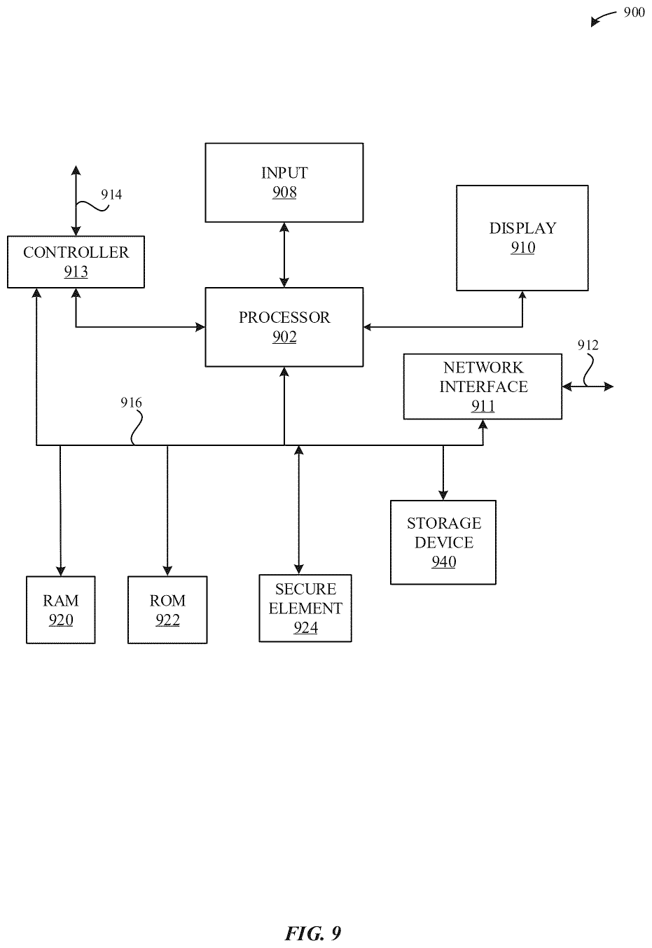

FIG. 9 illustrates a detailed view of a representative computing device 900 that can be used to implement various methods described herein, according to some embodiments. In particular, the detailed view illustrates various components that can be included in the wireless device 102, any of the wireless devices 102A, 102B, 102C, and 102D, or any other wireless device as discussed herein. As shown in FIG. 9, the computing device 900 can include a processor 902 that represents a microprocessor or controller for controlling the overall operation of computing device 900. The computing device 900 can also include a user input device 908 that allows a user of the computing device 900 to interact with the computing device 900. For example, the user input device 908 can take a variety of forms, such as a button, keypad, dial, touch screen, audio input interface, visual/image capture input interface, input in the form of sensor data, etc. Still further, the computing device 900 can include a display 910 that can be controlled by the processor 902 to display information to the user. A data bus 916 can facilitate data transfer between at least a storage device 940, the processor 902, and a controller 913. The controller 913 can be used to interface with and control different equipment through an equipment control bus 914. The computing device 900 can also include a network/bus interface 911 that communicatively couples to a data link 912. In the case of a wireless connection, the network/bus interface 911 can include a wireless transceiver.

The computing device 900 also includes a storage device 940, which can comprise a single disk or a plurality of disks (e.g., hard drives), and includes a storage management module that manages one or more partitions within the storage device 940. In some embodiments, storage device 940 can include flash memory, semiconductor (solid state) memory or the like. The computing device 900 can also include a Random Access Memory (RAM) 920 and a Read-Only Memory (ROM) 922. The ROM 922 can store programs, utilities or processes to be executed in a non-volatile manner. The RAM 920 can provide volatile data storage, and stores instructions related to the operation of the computing device 900. The computing device 900 can further include a secure element (SE) 924, which can represent secure storage for credentials for cellular wireless system access by the computing device 900. The secure element 924 can include an eUICC on which to store one or more eSIMs (e.g., one or more eUICCs 108), one or more UICCs 118 that store SIM or eSIM credentials (profiles), and/or a processor and/or chip component in a system on chip (SoC) module that stores iSIM credentials (profiles).

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

Cellular wireless access credentials to provide access to cellular wireless services of a cellular wireless service provider can be installed in a wireless device in a variety of forms including but not limited to a universal integrated circuit card (UICC) storing a Subscriber Identity Module (SIM), an embedded UICC (eUICC) storing an electronic SIM (eSIM), or in hardware, such as a processor of system on chip (SoC) module storing an integrated SIM (iSIM). The embodiments described herein can apply to all of these type of implementations. A UICC storing a SIM can also be referred to as a SIM card. A SIM, eSIM, or iSIM can also be referred to as a SIM profile, an eSIM profile, or an iSIM profile respectively, or simply as a profile.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for managing both a consumer context and an Internet of Things (IoT) context relative to utilizing at least one consumer-related electronic Subscriber Identity Module (eSIM) and at least one IoT-related eSIM, respectively, the method comprising:
providing, to an embedded Universal Integrated Circuit Card (eUICC), a terminal capability command that indicates both the consumer context and the IoT context should be managed;
providing, to the eUICC, at least one first function call that indicates the consumer context, wherein the consumer context causes the eUICC to, based on the consumer context and the at least one consumer-related eSIM:
process the at least one first function call, and
provide at least one first response to the at least one first function call; and/or
providing, to the eUICC, at least one second function call that indicates the IoT context, wherein the IoT context causes the eUICC to, based on the IoT context and the at least one IoT-related eSIM:
process the at least one second function call, and
provide at least one second response to the at least one second function call.

2. The method of claim 1, further comprising, prior to providing the terminal capability command:
receiving, from the eUICC, an indication that the eUICC supports eUICC functionalities.

3. The method of claim 1, wherein the terminal capability command is provided in response to an Answer-To-Reset (ATR) triggered by a power-on event or a reset event.

4. The method of claim 1, further comprising:
receiving, from the eUICC in response to the terminal capability command, a confirmation that the eUICC is managing both the consumer context and the IoT context.

5. The method of claim 1, further comprising:
providing, to the eUICC, an Issuer Security Domain-Root (ISD-R) selection command; and
receiving, from the eUICC, a File Control Information (FCI) template that indicates both the consumer context and the IoT context.

6. The method of claim 1, wherein:
the terminal capability command includes a tag-length-value (TLV) package; and
the TLV package includes first and second bytes that identify at least one consumer-related functionality and at least one IoT-related functionality, respectively.

7. The method of claim 1, wherein:
the terminal capability command includes first and second TLV packages;
the first TLV package includes one byte that identifies at least one consumer-related functionality; and
the second TLV package includes one byte that identifies at least one IoT-related functionality.

8. A method for managing both a consumer context and an Internet of Things (IoT) context relative to utilizing at least one consumer-related electronic Subscriber Identity Module (eSIM) and at least one IoT-related eSIM, respectively, the method comprising:
providing, to an embedded Universal Integrated Circuit Card (eUICC), a terminal capability command that indicates both the consumer context and the IoT context should be managed;
identifying at least one first condition under which to call at least one first function pertaining to the consumer context and/or at least one second condition under which to call at least one second function pertaining to the IoT context;
providing, to the eUICC, a consumer context switch command that causes the eUICC to, based on the consumer context and the at least one consumer-related eSIM, and until further notice is received, (i) process particular function calls including the first function call, and (ii) provide first responses to the particular function calls; and/or
providing, to the eUICC, an IoT context switch command that causes the eUICC to, based on the IoT context and the at least one IoT-related eSIM, and until further notice is received, (i) process the particular function calls including the second function call, and (ii) provide second responses to the particular function calls.

9. The method of claim 8, further comprising, prior to providing the terminal capability command:
receiving, from the eUICC, an indication that the eUICC supports eUICC functionalities.

10. The method of claim 8, wherein the terminal capability command is provided in response to an Answer-To-Reset (ATR) triggered by a power-on event or a reset event.

11. The method of claim 8, further comprising:
receiving, from the eUICC in response to the terminal capability command, a confirmation that the eUICC is managing both the consumer context and the IoT context.

12. The method of claim 8, further comprising:
providing, to the eUICC, an Issuer Security Domain-Root (ISD-R) selection command; and
receiving, from the eUICC, a File Control Information (FCI) template that indicates both the consumer context and the IoT context.

13. The method of claim 8, wherein:
the terminal capability command includes a tag-length-value (TLV) package; and
the TLV package includes first and second bytes that identify at least one consumer-related functionality and at least one IoT-related functionality, respectively.

14. The method of claim 8, wherein:
the terminal capability command includes first and second TLV packages;
the first TLV package includes one byte that identifies at least one consumer-related functionality; and
the second TLV package includes one byte that identifies at least one IoT-related functionality.

15. A method for managing both a consumer context and an Internet of Things (IoT) context relative to utilizing at least one consumer-related electronic Subscriber Identity Module (eSIM) and at least one IoT-related eSIM, respectively, the method comprising, by an embedded Universal Integrated Circuit Card (eUICC):
receiving a terminal capability command that indicates both the consumer context and the IoT context should be managed;
receiving at least one first function call that indicates the consumer context; and
based on the consumer context and the at least one consumer-related eSIM, (i) process the at least one first function call, and (ii) provide at least one first response to the at least one first function call; and/or
receiving at least one second function call that indicates the IoT context; and
based on the IoT context and the at least one IoT-related eSIM, (i) process the at least one second function call, and (ii) provide at least one second response to the at least one second function call.

16. The method of claim 15, further comprising, prior to receiving the terminal capability command:
providing an indication that the eUICC supports eUICC functionalities.

17. The method of claim 15, wherein:
the terminal capability command is communicated by at least one of an application processor or a baseband processor; and
the terminal capability command is provided in response to an Answer-To-Reset (ATR) triggered by a power-on event or a reset event.

18. The method of claim 15, further comprising:
providing, in response to the terminal capability command, a confirmation that both the consumer context and the IoT context are being managed.

19. The method of claim 15, further comprising:
receiving an Issuer Security Domain-Root (ISD-R) selection command; and
providing a File Control Information (FCI) template that indicates both the consumer context and the IoT context.

20. The method of claim 15, wherein:
the terminal capability command includes a tag-length-value (TLV) package; and
the TLV package includes first and second bytes that identify at least one consumer-related functionality and at least one IoT-related functionality, respectively.
